(19) United States
(12) Patent Application Publication
(10) Pub. No.: US 2005/0254995 A1
(43) Pub. Date: Nov. 17, 2005

(54) Devices and methods to immobilize analytes of interest

(75) Inventors: Ronald Sostek, Holliston, MA (US); Cecily Periana, Holliston, MA (US); Mark Davis, Holliston, MA (US)

Correspondence Address: WILMER CUTLER PICKERING HALE AND DORR LLP, THE WILLARD OFFICE BUILDING, 1455 PENNSYLVANIA AVE, NW, WASHINGTON, DC, 20004, US

(73) Assignee: Harvard Apparatus, Inc., Holliston, MA (US)

(21) Appl. No.: 10/843,615

(22) Filed: May 12, 2004

(51) Int. Cl. G01N 21/00

(52) U.S. Cl. 422/56; 422/70

(57) ABSTRACT

The invention provides devices and methods using assemblies of shaped inserts coated with diverse binder materials optionally positioned inside conformal housings. The devices are capable of immobilizing target analytes of interest (e.g., specific or groups of biomolecules) and are optionally usable as single units, linear strips or array formats. The coatings on the inserts and, optionally also on the inside walls of the housings, create variable gaps with narrow fluid paths resulting in enhanced diffusion and absorption of target analytes from transiting fluid samples while exhibiting minimal resistance to flow or back pressure commonly seen in conventional plug-type packings. The devices are intended for sample preparations requiring: filtering, enriching, separating, purifying of target analytes by selective absorption/elution as part of desalting, buffer exchange and/or enrichment applications in analyses by mass spectrometry and/or electrophoresis; purifying biomolecules; culturing cells; analytical separation processes, and general chemical, biological and/or biochemical separations in manual or automated systems.

### FIELD OF THE INVENTION

The invention provides devices and methods that can immobilize analytes of interest in chemical, analytical, biochemical and/or biological applications. Immobilizing analytes of interest from liquid samples allows for filtering, separating, purifying, quantifying, characterizing, enriching, and/or identifying analytes of interest prior to analysis or identification of the analytes of interest by mass spectrometry, high performance liquid chromatography, electrophoresis, gas chromatography, UV spectrophotometry, and other analytical techniques.

### BACKGROUND OF THE INVENTION

Currently available methods for the separation and purification of analytes in micro-volumes by centrifugation or column methods often result in undesirable sample loss. Since the amount and concentration of target analytes, such as proteins or bio-molecules, in a fluid sample is often low, the loss of even a small amount of the target analyte can represent a significant portion of the total analyte contained therein. In current methods, target analyte losses often result from the target analyte becoming trapped in filters or other column components. Liquid sample processing is difficult due to high resistance to fluid flow or undesirable increases in back pressure. For example, the device described in U.S. Pat. No. 6,200,474 consists of a micropipette tip containing a cast column material that is formed as a plug at the lower end of the tip. Since the material plugs the tip end through which the liquid sample is drawn, the flow of the liquid sample in both directions is impeded. Consequently, when such tips are used in multi-tip configurations, variations in sample fluid flow may cause inconsistencies in the quantities of target analytes absorbed in different tips and the quality of the sample separation process.

There is a need in the art for new and improved devices that provide more efficient methods for enriching and purifying target analytes in micro-volumes of fluid samples with minimal samples loss and little or no back pressure. The invention is directed to this, as well as other, objectives.

### SUMMARY OF THE INVENTION

The invention provides improved liquid sample processing by separation and enrichment of target analytes from liquid samples due to rapid and efficient immobilization of the analytes to the binding materials on the surfaces of inserts inside pipette tips and/or housings. The size and shape of the insert can be controlled to produce a conformal annular gap between the surface of the insert and the inside wall of the housing. The conformal annular gap provides an open channel for the liquid sample to flow through at high diffusion rates that favor rapid analyte binding and minimal back pressure thereby allowing more rapid sample processing at higher enrichment ratios than can be achieved with currently available tip formats.

The invention provides inserts that are at least partially coated with binding materials that can immobilize an analyte of interest from a liquid sample. The binding materials can optionally be in the form of a matrix with one or more polymers. In other embodiments, the insert can optionally be coated with secondary supports, where the secondary supports are coated with the binding materials, but where the insert itself is not coated with the binding materials. In still other embodiments, both the inserts and the secondary supports can be coated with the binding materials that have at least one functionality that can immobilize an analyte of interest. The inserts have a three-dimensional body that is of a size and shape that is capable of being placed into a housing. In another embodiment, the invention provides a linear strip or an array comprising a plurality of inserts. For example, the array can contain 2, 4, 8, 12, 16, 24, 48, 96, 384 or 1,536 inserts of the invention.

The invention provides housings defining a volume and comprising an open top end, and an insert comprising binding materials that have at least one functionality that can immobilize an analyte of interest; where the insert is within the volume of the housing; where the insert does not significantly obstruct analyte flow through the housing; and where the insert does not create substantial back pressure. In other embodiments, the insert can optionally be coated with secondary supports, where the secondary supports are coated with the binding materials, but where the insert itself is not coated with the binding materials. In still other embodiments, both the inserts and the secondary supports can be coated with the binding materials. The device can comprise a plurality of housings in the form of a linear strip or an array having, for example, 2, 4, 8, 12, 16, 24, 48, 96, 384 or 1,536 housings.

The invention provides methods for enriching an analyte of interest using the inserts described herein. In one embodiment, the methods comprise the steps of (i) providing an insert that is at least partially coated with binding materials that are capable of reversibly immobilizing an analyte of interest; (ii) providing a housing with a closed bottom end where the housing comprises a liquid sample which comprises the analyte of interest and, optionally, one or more contaminates; (iii) immersing the insert into the liquid in the housing for a period of time sufficient for the binding materials to immobilize the analyte of interest; (iv) removing the insert from the housing; (v) washing the insert with an appropriate solvent to elute the analyte of interest from the binding materials; and (vi) collecting the enriched analyte of interest. In an alternative embodiment, the insert can be placed into the housing and then the liquid sample can be added to the housing. In other embodiments, steps (iii) and (iv) can be repeated two, three, four, five or more times. The methods can be manual or automated.

The invention provides methods for enriching an analyte of interest comprising the steps of (i) providing an array of linked inserts where the inserts are at least partially coated with binding materials that are capable of reversibly immobilizing an analyte of interest; (ii) providing an array of linked housings with a closed bottom end, where the housings comprise a liquid sample, and where the liquid sample comprises the analyte of interest and, optionally, one or more contaminates; (iii) immersing the array of inserts into the liquid sample in the array of housings for a period of time sufficient for the binding materials to immobilize the analyte of interest; (iv) removing the array of inserts from the array of housings; (v) washing the array of inserts with an appropriate solvent to remove or elute the analyte of interest from the binding materials; and (vi) collecting the enriched analyte of interest. In an alternative embodiment, the array of inserts can placed in the array of housings, and then the liquid can be added to the array of housings. In other embodiments, steps (iii) and (iv) can be repeated two, three, four, five or more times. The methods can be manual or automated.

The invention provides methods for enriching an analyte of interest comprising the steps of (i) providing a first housing that has at least one open end (preferably an open bottom end) and an insert, wherein the insert is at least partially coated with binding materials that are capable of reversibly immobilizing an analyte of interest; (ii) providing a second housing with a closed bottom end, where the second housing comprises a liquid sample which comprises the analyte of interest and, optionally, one or more contaminates; (iii) immersing the first housing into the liquid sample in the second housing for a period of time sufficient for the binding materials to immobilize the analyte of interest; (iv) removing the first housing from the second housing; (v) washing an appropriate solvent through the first housing to remove the analyte of interest from the binding materials; and (vii) collecting the enriched analyte of interest. In an alternative embodiment, the first housing can be placed into the second housing, and then the liquid sample can be added to either the first housing and/or the second housing. In another alternative embodiment with respect to step (vi), the insert can be removed from the first housing prior to washing with an appropriate solvent to remove the analyte of interest. In other embodiments, steps (iii) and (iv) can be repeated two, three, four, five or more times. The methods can be manual or automated.

In another embodiment, the invention provides methods for enriching an analyte of interest comprising the steps of (i) providing an array of first linked housings that have at least one open end (preferably an open bottom end) and an insert, where the insert is at least partially coated with binding materials that are capable of reversibly immobilizing an analyte of interest; (ii) providing an array of second (optionally linked) housings that have a closed bottom end, where the second housings comprise a liquid sample, and where the liquid sample comprises the analyte of interest and, optionally, one or more contaminates; (iii) immersing the array of first housings into the liquid sample in the array of second housings for a period of time sufficient for the binding materials to immobilize the analyte of interest; (iv) removing the array of first housings from the array of second housings; (v) washing an appropriate solvent through the array of first housings to remove the analyte of interest from the binding materials; and (vi) collecting the enriched analyte of interest. In an alternative embodiment with respect to step (i), an array of inserts can be placed into the array of first housings, and the inserts can optionally remain in the form of an array or the inserts can be detached from their array to form individual inserts in the housing array. In an alternative embodiment, the array of first housings can be placed into the array of second housings, and then the liquid sample can be added to either the array of first housings and/or the array of second housings. In another alternative embodiment with respect to step (vi), the inserts or array of inserts can be removed from the array of first housings prior to washing with an appropriate solvent to remove the analyte of interest. In other embodiments, steps (iii) and (iv) can be repeated two, three, four, five or more times. The methods can be manual or automated.

These and other aspects of the invention are described in more detail herein.

### BRIEF DESCRIPTION OF THE DRAWINGS

FIG. 1A shows an insert of the invention partially coated with binding materials.

FIG. 1B shows an insert of the invention coated with secondary supports, where only the secondary supports are coated with binding materials. The binding materials can coat all or a portion of the secondary supports, and the secondary supports can coat all or a portion of the insert.

FIG. 1C shows an insert of the invention coated with secondary supports where both the insert and the secondary supports are coated with binding materials. The binding materials can coat all or a portion of the secondary supports and/or insert. Similarly, the secondary supports can coat all or a portion of the insert.

FIG. 1D shows an insert of the invention having an asymmetrical double conical shape where the lower, larger conical shape is coated with binding materials. The insert also has an optional handle which can assist during coating of the binding material and/or placement of the insert into a housing. The optional handle can be part of a link forming an array of inserts.

FIG. 1E is one embodiment of a top view of the insert shown in FIG. 1D, and shows that the insert has a smooth, circular outer surface.

FIG. 1F is one embodiment of a top view of the insert shown in FIG. 1D, and shows that the insert can have a ribbed outer surface. If the insert shown in FIG. 1F was placed in a housing, the ribbed surface would provide flow channels between the insert and the inner wall of the housing.

FIG. 2A shows a housing (e.g., tube) and insert coated with binding materials. The insert is suspended in the sample flow path within the housing because the insert is magnetic, has a magnetic core and/or is magnetizable. The external magnetic and/or magnetic field is not shown.

FIG. 2B is a top view of the housing shown in FIG. 2A.

FIG. 3A shows a housing (e.g., pipette tip) and insert coated with secondary supports which are coated with binding materials. The insert is suspended in the liquid sample flow path within the housing because the insert is magnetic, has a magnetic core and/or is magnetizable. The external magnetic and/or magnetic field is not shown.

FIG. 3B is a top view of the housing shown in FIG. 3A.

FIG. 4A shows a housing (e.g., container) and insert coated with secondary supports where both the insert and secondary supports are coated with binding materials. The insert is floating in the liquid sample in the fluid flow path within the housing because the insert is buoyant.

FIG. 4B is a top view of the housing shown in FIG. 4A.

FIG. 5A shows a housing (e.g., pipette tip) and insert of the invention, where a portion of the insert is coated with binding materials. The insert is attached to a structural element that holds the insert in place within the liquid sample flow path in the housing.

FIG. 5B is one embodiment of a top view of the housing shown in FIG. 5A. FIG. 5B shows that the structure shown in FIG. 5A does not significantly block the liquid sample flow path in the housing because the ribbed structure provides for flow channels.

FIG. 5C is another embodiment of a top view of the housing shown in FIG. 5A. FIG. 5C shows that the structure shown in FIG. 5A does not significantly block the liquid sample flow path through the housing because there are flow channels in the structure.

FIG. 6 shows a housing (e.g., pipette tip) and insert coated with secondary supports that are coated with binding materials. The insert is suspended within the liquid sample flow path in the housing. At least a portion of the inside wall of the housing has a coating comprising binding materials and, optionally, an inert material.

FIG. 7 shows a housing (e.g., pipette tip) and insert coated with binding materials. The insert is attached to a structure that holds the insert in place within the housing. At least a portion of the inside wall of the housing has binding materials embedded therein.

FIG. 8 shows an array of inserts, where at least a portion of the inserts are coated with binding materials. The inserts have handles that are removably or permanently attached to a primary linking device to form the array.

FIG. 9 shows an array of inserts, such as those described in FIG. 8, that are placed into an array of housings, such as pipette tips. The array of inserts can optionally be linked together. Similarly, the array of housings can optionally be linked together.

FIG. 10A shows that the inserts can be disconnected from the array via the handle from the primary linking device so that the individual inserts can be placed into the housings, which are optionally part of an array.

FIG. 10B is a top view of the housing and insert shown in FIG. 10A. The insert can be held in place within the housing by physically touching the inside walls of the housing. The flow channels created at the surface of the inserts do not significantly obstruct the liquid sample flow through the housing and do not create significant back pressure.

FIG. 11A shows an array of inserts where at least a portion of the inserts are coated with binding materials. The inserts have handles that are removably or permanently attached to a primary linking device to form the array.

FIG. 11B shows an array of containers holding a liquid sample, where the liquid sample contains an analyte of interest, contaminants and, optionally, other undesirable materials.

FIG. 12 shows an array of inserts being immersed into the liquid sample in an array of containers so that the liquid sample surrounds and/or flows around the inserts. The binding materials on the inserts can selectively bind to and immobilize the analyte of interest in the liquid sample.

FIG. 13A shows an array of inserts after they have been removed from a liquid sample containing analytes of interest. The binding materials on the inserts are bound to the analytes of interest that were in the liquid sample.

FIG. 13B shows the array of containers after the inserts of the invention have been removed. The remaining liquid sample in the array of containers contains mainly contaminants. There may be some analyte of interest remaining in the liquid sample depending on the experimental conditions used (e.g., binding affinity between the binding materials and analyte of interest; length of time the insert was immersed in the liquid sample; amount of analyte of interest in the liquid sample in view of the volume of liquid in the container, etc.).

FIG. 14A shows a housing (e.g., pipette tip) and insert of the invention, where the insert and secondary supports are both coated with binding materials. The ends or edges of the insert physically touch the inside walls of the housing to hold the insert in place within the housing. The ends or edges of the insert can optionally be physically connected to the inside wall of the housing. The insert does not significantly block the fluid flow through the housing and does not create significant back pressure.

FIG. 14B is one cross-sectional view of the housing shown in FIG. 14A, and shows that the cross-sectional shape of the insert can be triangular, that the ends or edges of the insert physically contact the inside wall of the housing, that the insert creates liquid sample flow channels which do not significantly obstruct the liquid sample flow through the housing, and that the insert does not create significant back pressure.

FIG. 14C is another cross-sectional view of the housing shown in FIG. 14A, and shows that the cross-sectional shape of the insert can be square, that the ends or edges of the insert physically contact the inside wall of the housing, that the insert creates liquid sample flow channels which do not significantly obstruct the liquid sample flow through the housing, and that the insert does not create significant back pressure.

FIG. 14D is a cross-sectional view of the housing shown in FIG. 14A, and shows that the cross-sectional shape of the insert can be star-shaped, that the ends or edges of the insert physically contact the inside wall of the housing, that the insert creates liquid sample flow channels which do not significantly obstruct the liquid sample flow through the housing, and that the insert does not create significant back pressure.

### DETAILED DESCRIPTION OF THE INVENTION

The invention provides improved devices and methods that facilitate analyte preparation, including analyte enrichment, purification, separation, filtration, and/or identification processes that minimize sample loss and process variability. The devices and methods are ideally suited for efficient automated (e.g., robotic) and manual applications (e.g., pipettors) using microliter sample volumes because of their low back pressure (i.e., low resistance to liquid flow) characteristics.

The inserts of the invention can be any three-dimensional size or shape. The inserts can be shaped or molded to be complementary to the inside volume of a housing (e.g., pipette tip). For example, the insert can be in the three-dimensional shape of a cube, cylinder, sphere, oval, cone, rectangle, pyramid, or combination thereof. As another example, the cross-sectional shape of the insert can be in the form of a square, rectangle, pentagon, hexagon, octagon, star, triangle, or combination thereof. The insert can be flexible, rigid or a combination thereof. In other embodiments, the insert can have a vertically ribbed surface, where the peaks and valleys of the ribbed surface provide liquid flow channels between the insert and the inside wall of a housing when the insert is placed within a housing. The inserts can be porous or non-porous. The inserts can be cast, polymerized or molded. The inserts can be magnetic, magnetizable and/or have a magnetic core. The inserts can be capable of floating in a liquid. The insert can be made of one or more inert materials. Exemplary inert materials include polymers, organic materials, inorganic materials, metals, ceramics, and the like. Exemplary polymers that can be used to make the insert include polytetrafluoroethylenes (e.g., TEFLON® from DuPont), polysulfones, polyethersulfones, cellulose acetates, polystyrenes, polypropylene, polyvinylchlorides, polycarbonates, polystyrene/acrylonitrile copolymers, polyvinylidenefluorides, or mixtures of two or more thereof. The inserts can be made of and/or covered with fabric, woven fabrics, mesh, fibers, paper and the like.

The inserts of the invention can be in a singular format, a strip format (e.g., a linear strip) or an array format. The strip or array can comprise a plurality of inserts, for example, 2, 4, 8, 12, 16, 24, 48, 96, 384 or 1,536 inserts of the invention. The inserts can be used with microtiter plates in which the wells of the microtiter plates serve as housings or, alternatively, as reservoirs for the liquid samples to be purified by means of the inserts of the invention.

The inserts of the invention are at least partially coated with one or more binding materials that have at least one functionality that can immobilize an analyte of interest when a liquid sample containing the analyte of interest flows past and/or is in contact with the binding materials. “Immobilize” means that the binding materials are capable of physically and/or chemically (e.g., covalent, ionic, hydrophobic, hydrogen bonding, Van der Waals dispersion forces, dipole-dipole attractions) bonding to or adhering an analyte of interest. The inserts can be at least partially coated with one or more different binding materials that can immobilize one or more different analytes of interest. The binding materials can reversibly or irreversibly immobilize an analyte of interest. Immobilizing an analyte of interest is useful and necessary to purify, enrich, filter and/or identify the analyte of interest.

In one embodiment, the binding materials provide substantially complete reversible immobilization of the analyte of interest. Substantially complete reversible immobilization of the analyte of interest (e.g., substantially complete elution of analytes bound to the binding materials) in the same relative proportions and amounts as found in the original sample is highly desirable. Efficient purification and enrichment procedures for analytes should qualitatively and quantitatively reflect the composition of the analyte in the original liquid sample (e.g., for mass spectral analysis of analyte profiles).

Exemplary methods to apply or coat the binding materials onto the insert include chemical bonding (e.g., hydrophobic, covalent, ionic, and the like) of the binding materials to the insert or to a coating (e.g., fabric, chromatographic material) on the insert and/or physical bonding of the binding materials via chemicals, heat, pressure and/or etching to the insert or to a coating on the insert. For example, the binding materials can be in admixture with a coating on the surface of the insert; the binding materials can be in admixture with the surface of the insert; and/or the binding materials can be partially embedded in the surface of the insert. In alternative embodiments, the binding materials of the invention can be located on the inside of the insert, in which case the insert is preferably a porous insert. In still other embodiments, the binding materials can be located on both the outside of the insert and the inside of the insert.

The binding materials can be any known in the art. One skilled in the art will readily be able to select the binding materials based on the binding capacity between the binding materials and the analyte of interest. The binding materials are substantially inert and stable in gas environments (e.g., air). Exemplary binding materials include polymers, chromatographic materials, nucleotides, proteins, ligands, enzymes, antibodies, dyes, bacteria, cells, cyclodextrins, lectins, metal ions, or mixtures of two or more thereof. In other embodiments, the binding materials can be poly-L-lysine, poly-D-lysine, DEAE-dextran, poly-L-arginine, poly-L-histine, poly-DL-ornithine, protamine, collagen type 1, collagen type IV, gelatin, fibronectin, laminin, chondronectin, or mixtures of two or more thereof. In one embodiment, the binding materials reversibly immobilize one or more analytes of interest.

In one embodiment, the binding materials that can immobilize an analyte of interest can be one or more chromatographic materials. Exemplary chromatographic materials include materials for ion-exchange chromatography, size-exclusion chromatography, affinity chromatography, gradient chromatography, hydrophobic chromatography, chiral chromatography, reverse phase chromatography, and mixtures of two or more thereof. Exemplary chromatographic materials include polysaccharides (e.g., cellulose, agarose, crosslinked polysaccharide beads {commercially available as SEPHAROSE® and SEPHADEX®}), polymers (e.g., polystyrene, polypropylene, polytetrafluoroethylenes {e.g., TEFLON® from DuPont}, styrenedivinyl-benzene based media, polymer beads, poly(methyl methacrylates) {PERSPEX®}, polyacrylamide), silicas (e.g., silica, silica gel, silica gel-containing phosphors, glass, controlled pore glass {CPG}), and/or metals and/or metal oxides (e.g., aluminum oxide, zirconium, titanium). The chromatographic materials can be chemically and/or physically modified, and may be porous or non-porous. For example, styrenedivinyl-benzene based media may be modified with, for example, sulphonic acids, quarternary amines and the like. Chromatographic materials may be physically and/or chemically modified with, for example, enzymes, antibodies, cyclodextrins, lectins, metal ions, and/or ligands. The ligands can be C₁₋₂₄ alkyl ligands, such as C₂, C₄, C₆, C₈, C₁₀, C₁₂, C₁₄, C₁₆ and/or C₁₈ alkyl ligands. The chromatographic materials may have any regular (e.g., spherical) or irregular shape, or may be shards, fibers, mesh, cloth, powders or mixtures thereof. The chromatographic materials can have a particle size of about 1 μm to about 1,000 μm; from about 5 μm to about 500 μm; or from about 10 μm to about 100 μm.

In one embodiment, the binding materials are reverse phase chromatographic materials that are bonded to a polymeric coating (e.g., polytetrafluoroethylene) on the insert and/or to a polymeric insert. In another embodiment, the binding materials are alkyl ligands covalently bonded to a polymeric coating and/or a polymeric insert. The alkyl ligands can be C₁ to C₂₄ alkyl ligands or mixtures of two or more thereof. In other embodiments, the alkyl ligands are C₂, C₄, C₆, C₈, C₁₀, C₁₂, C₁₄, C₁₆, C₁₈ alkyl ligands or mixtures of two or more thereof. In other embodiments, the alkyl ligands are C₂, C₄, C₈, C₁₂, C₁₈ alkyl ligands or mixtures of two or more thereof. In another embodiment, the invention provides C₁₈ alkyl ligands covalently bonded to polytetrafluoroethylene (i.e., TEFLON® by DuPont), where the polytetrafluoroethylene is a coating on the insert and/or is the insert itself.

In one embodiment, the binding materials that can immobilize an analyte of interest can be in a matrix (e.g., admixture) with one or more polymers known in the art. Exemplary polymers include polytetrafluoroethylenes (e.g., TEFLON® by DuPont), polysulfones, polyethersulfones, cellulose acetates, polystyrenes, polyvinylchlorides, polycarbonates, polystyrene/acrylonitrile copolymers, polyvinylidenefluorides, or mixtures of two or more thereof. The polymers used in the matrix can be sticky polymers applied to the insert in volatile solvents or as solutions. These matrix polymers generally have minimal affinity for the analytes of interest and serve merely to partially embed the binding materials. The inserts of the invention can be pre-coated with the matrix polymers, followed by coating with the binding materials. Alternatively, a matrix coating comprising an admixture of the polymers and binding materials can be applied to the surface of the inserts. In one embodiment, the matrix coating comprises one or more hydrophilic polymers and one or more binding materials. Partially embedded binding materials (e.g., 10-100 μm sized hydrophobic chromatographic materials bearing alkyl ligands [e.g., C₄, C₈, C₁₂ and/or C₁₈ alkyl ligands]) can be used to modulate the width of the annular gap between the insert and the housing to increase the binding capacities, binding diffusion rates and enrichment ratios of the binding materials and analytes of interest. The enrichment ratio, defined as the ratio of the applied liquid sample volume to the elution volume, is preferably greater than 10 for applications in mass spectral analysis, electrophoresis and other applications where 1-2 μl liquid samples are analyzed without prior concentration of the analytes of interest.

In other embodiments, the insert can optionally be coated with one or more secondary support materials that are at least partially coated (e.g., physically and/or chemically modified) with binding materials that can immobilize an analyte of interest. The secondary supports can be coated on the insert by methods known in the art such as, for example, chemical bonding (e.g., hydrophobic, covalent, ionic, and the like) and/or physical bonding via chemicals, heat, pressure and/or etching. The secondary supports can be made of the same or different material as that of the insert itself, as described above. The secondary supports can be coated with binding materials such as those described herein.

The analyte of interest (i.e., target analyte) can be any material known in the art. Exemplary analytes of interest include biomolecules, DNA, RNA, nucleotides, polynucleotides, oligonucleotides, proteins, peptides, amino acids, carbohydrates, polymers, ligands, enzymes, antibodies, dyes, bacteria, cells, cyclodextrins, lectins, metal ions, and other chemical compounds, chemical moieties, or biologics, or mixtures/combinations of two or more thereof having affinities for specific biomolecules or groups of biomolecules. The analyte of interest preferably originates from a liquid sample. The analyte of interest can, for example, be dissolved and/or suspended in a liquid sample. The liquid sample can be aqueous or organic. In one embodiment, the liquid sample can be a mammalian bodily fluid, such as blood or urine. In one embodiment, the liquid sample is an aqueous liquid sample.

After the binding materials on the insert immobilize an analyte of interest, the analyte of interest can be released from the insert and binding materials using an appropriate solvent that would be capable of breaking the physical and/or chemical bond between the binding materials and the analyte of interest.

Although the invention has been described in detail herein, the following figures exemplify various non-limiting embodiments of the invention. One skilled in the art will appreciate that variations can be made to the devices and methods shown in the figures in view of the description herein.

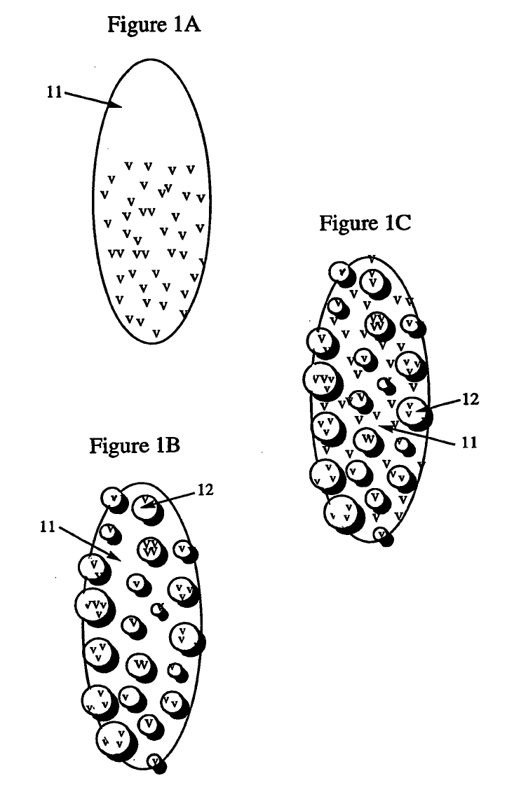

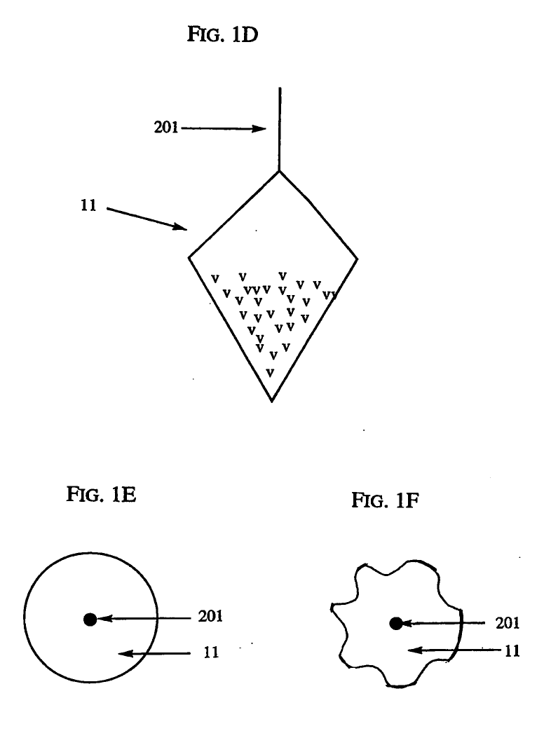

FIG. 1A shows an exemplary insert 11 of the invention. The insert 11 comprises binding materials v that have at least one functionality that can immobilize an analyte of interest. The insert 11 and binding materials v can be any known in the art, such as those described herein. The insert 11 can optionally be magnetic or magnetizable, and can be manipulated through an external magnetic field. In other embodiments, the insert 11 can be physically attached to a structure (not shown) at any point (e.g., top, bottom, sides) on the insert 11. Such a structure (not shown) would be useful in the process for making the insert; for holding the insert within a housing; and/or for use of the insert in an array.

FIG. 1B shows an exemplary insert 11 of the invention. The insert 11 is coated with secondary supports 12 which are coated with binding materials v. The secondary supports 12 allow for the presence of one or more binding materials v on the insert 11 due to the increased surface area when compared to the surface area of the insert 11 by itself. The insert 11, secondary supports 12, and binding materials v can be any known in the art, such as those described herein. The insert 11 can optionally be magnetic or magnetizable, and can be manipulated through an external magnetic field. In other embodiments, the insert 11 can be physically attached to a structure (not shown) at any point (e.g., top, bottom, sides) on the insert 11. Such a structure (not shown) would be useful in the process for making the insert; for holding the insert within a housing; and/or for use of the insert in an array.

FIG. 1C is an exemplary insert 11 of the invention that combines the embodiments of FIGS. 1A and 1B. In particular, FIG. 1C is an insert 11 that comprises secondary supports 12 where binding materials v are present on both the insert 11 and on the secondary supports 12. Such an embodiment maximizes the amount of binding materials v that can be used on the insert 11. The insert 11 can optionally be magnetic and/or magnetizable, and can be manipulated through an external magnetic field. In other embodiments, the insert 11 can be physically attached to a structure (not shown) at any point (e.g., top, bottom, sides) on the insert 11. Such a structure (not shown) would be useful in the process for making the insert; for holding the insert within a housing; and/or for use of the insert in an array.

FIG. 1D shows an exemplary insert 11 of the invention having an asymmetric double conical shape (e.g., the lower cone is longer than the upper cone). The insert 11 comprises binding materials v. The insert 11 has a handle 201 that can be used to facilitate manipulation of the insert before, during and/or after an analytical application and/or the handle 201 can be used in the process for making the insert 11, as described in the examples that follow. In other embodiments (not shown), the handle can be used to attach the insert to a device that can be used to hold an array of inserts. Another exemplary insert 11 can optionally have a symmetric double conical shape. The binding materials v can coat the entire insert 11 or a portion of the insert 11. In the embodiment shown in FIG. 1D, the binding materials v are coated on the lower cone of the asymmetric double conical insert 11. The insert 11 and binding materials v can be any known in the art, such as those described herein.

FIGS. 1E and 1F show top views of the asymmetric double conical shaped insert 11 shown in FIG. 1D. FIG. 1E shows that the top portion of the cone is not coated with binding materials. FIG. 1F shows that the face of the insert can have a ribbed surface. The ribbed surface forms flow channels that can allow for unimpeded fluid flow with minimal back pressure when the insert 11 is used in conjunction with a housing (not shown).

In another embodiment, the invention provides a novel housing containing an insert of the invention. The insert is located in what would normally be the flow path or center of the housing. The insert of the invention does not significantly block the flow path and does not create significant back pressure to the flow path. In one embodiment, the insert is suspended in the flow path within the housing, not creating significant back pressure to the flow path, and not significantly obstructing the flow through the housing, including the flow of liquid sample through the optional open bottom end of the housing.

“Not creating significant back pressure” means that the back pressure created by the insert of the invention is about 0 to about 15 psi greater than the back pressure when the insert of the invention is not being used. In other embodiments, “not creating significant back pressure” means that the back pressure created by the insert of the invention is about 0 to about 10 psi; about 0 to about 5 psi; or about 0 to about 3 psi greater than the back pressure when the insert of the invention is not being used.

Generally, the open volume in the area of the housing in which the insert of the invention is located (including any coating on the inside walls of the housing) is about 60% or less of the total volume of the housing excluding the insert and excluding any coating on the inside walls of the housing. In other embodiments, the open volume in the area of the housing in which the insert of the invention is located (including any coating on the inside walls of the housing) is about 50% or less, about 40% or less; about 30% or less; about 20% or less; or about 10% or less of the total volume of the housing excluding the insert and excluding any coating on the inside walls of the housing.

The housing can be of any shape or size in any configuration that is suitable for a given set of experimental conditions. The housing can be tube, column, pipette tip, syringe, container, flask, petri dish, test tube, beaker, microtiter well plates and the like. The housing can define a volume from femtoliters to thousands of liters; or from submicroliters to liters. In one embodiment, the housing defines a volume from about 0.0001 milliliters to about 1 liter; or from about 0.0001 milliliters to about 100 milliliters; or from about 0.001 milliliters to about 10 milliliters. In another embodiment, the housing defines a volume from about 0.1 microliter to about 10 milliliters.

The housing can be made of one material or a combination of materials known in the art, and can optionally have one or more coatings on the inside and/or outside of the housing. In one embodiment, the housing comprises a polymer, a glass, a metal, a ceramic, or a mixture of two or more thereof. Exemplary polymers include polytetrafluoroethylene (e.g., TEFLON® by DuPont), polypropylene, polysulfone, polyethersulfone, cellulose acetate, polystyrene, polystyrene/acrylonitrile copolymer and PVDF. The glass can be PYREX® (Corning, Inc.). The housing can be transparent, translucent or opaque. In one embodiment, the inside walls of the housing are coated with one or more polymers, such as polytetrafluorethylene (e.g., TEFLON® by DuPont).

The inside wall of the housing may optionally be modified (e.g., physically and/or chemically) with any binding materials known in the art that are capable of immobilizing an analyte of interest, such as those described herein. The binding materials can be in the form of a matrix, such as that described herein.

The housing can be in a singular format, a strip format (e.g., a linear strip) or an array format. The strip format and array format can comprise a plurality of housings, such as a 2, 4, 8, 12, 16, 24, 48, 96, 384 or 1,536-housings. For example, a 96 pipette tip housing array can be used for the simultaneous preparation of up to 96 samples. Such multi-tip configurations can be designed with different numbers of tips forming the multi-tip system.

The insert is suspended in the liquid sample flow path within the housing. The insert can be a removable insert or the insert can be physically attached to the interior of the housing, optionally through a support mechanism. The insert can be in physical contact with but not connected to the inside walls of the housing provided that the liquid sample flow path is not significantly obstructed and provided that the insert does not create significant back pressure. Alternatively, the insert can be physically connected to the inside walls of the housing provided that the liquid sample flow path is not significantly obstructed and provided that the insert does not create significant back pressure. In one embodiment, the insert is physically touching the inside walls of the housing, but is not physically connected to the inside walls of the housing.

In another embodiment, the insert can be attached to and/or suspended from a structure that is attached to a wall of the housing, provided that the structure does not significantly obstruct the analyte flow through the housing and provided that the structure does not create significant back pressure. Generally, the structure will be closer to the top end of the housing, although other embodiments can be used. The structure can be any inert material that does not interfere with the liquid sample or the analyte of interest. The structure can optionally be made of the same material as the housing and/or the insert. The structure can be physically attached to the housing; can be set within the housing after the housing is made and before sample preparation begins (i.e., removably attached); or can be suspended within the housing from a structure outside the housing. In one embodiment, the structure can be coated with binding materials, such as those described herein, that are capable of immobilizing an analyte of interest

In one embodiment, the insert can be magnetic, can have a magnetic core, and/or can be magnetizable, such that the insert can be freely suspended within the analyte flow path in the housing during use. Such an embodiment requires the use of a magnet or magnetic field outside the housing.

In another embodiment, the insert is inside the housing. When a liquid sample enters the housing the insert is capable of floating in the liquid sample. An insert that floats in the liquid sample will not significantly obstruct the flow path and will not create significant back pressure.

As one example for optimal analyte immobilization, the liquid sample can be aspirated through the flow channels created by the insert in the housing to ensure optimal binding of the desired analyte of interest to the binding materials on the insert. The analyte of interest can then be eluted from the binding materials on the insert using different solvents.

The elution volume is preferably less than or equal to the void volume in the channel between the walls of the housing and the coated portion of the insert and can range from about 1 to about 100 μl for optimal analyte enrichment starting with a sample volume of about 20 μl to about 1,000 μl, respectively. The elution volume is optimally a fraction of the gap volume or space between the walls of the housing and the insert (including the volume of the support and coating). The enrichment ratio is the sample volume divided by the elution volume. For example, a sample volume of 100 μl and an elution volume of 5 μl yields an enrichment ratio of 20. The enrichment ratio for the device of the invention is preferably about 10 or more, about 15 or more, or about 20 or more.

Although the invention has been described in detail herein, the following figures exemplify various non-limiting embodiments of the invention. One skilled in the art will appreciate that variations can be made to the devices shown in the figures in view of the description herein.

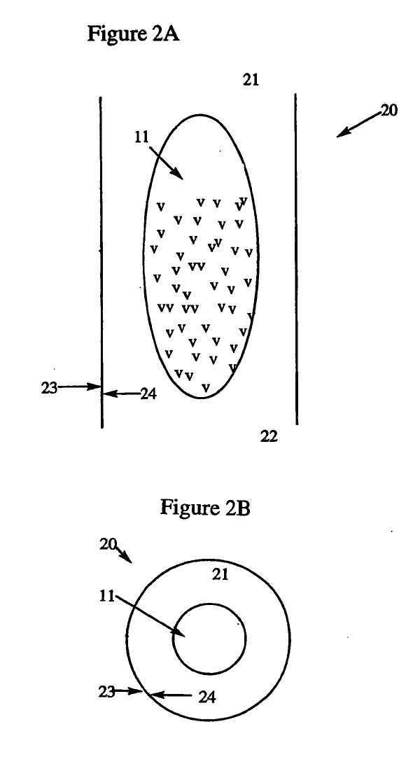

FIG. 2A is a housing (e.g., tube) 20 that has an open bottom end 22, an open top end 21, an exterior wall 23 and an interior wall 24. The housing 20 contains an insert 11 coated with binding materials v that have at least one functionality that can immobilize an analyte of interest. The insert 11 is magnetic and/or magnetizable, and is suspended in the analyte flow path in the housing 20. The external magnetic field is not shown.

FIG. 2B is a top view of the housing 20 of FIG. 2A. The housing 20 has an exterior wall 23 and an interior wall 24. As can be seen from FIG. 2B, the insert 11 is suspended within the liquid sample flow path of the housing 20, the insert 11 is not physically attached to the inside wall of the housing 20, and the insert 11 does not significantly block the flow of liquid sample through the housing 20, and the insert does not create significant back pressure in the housing. The external magnetic field is not shown.

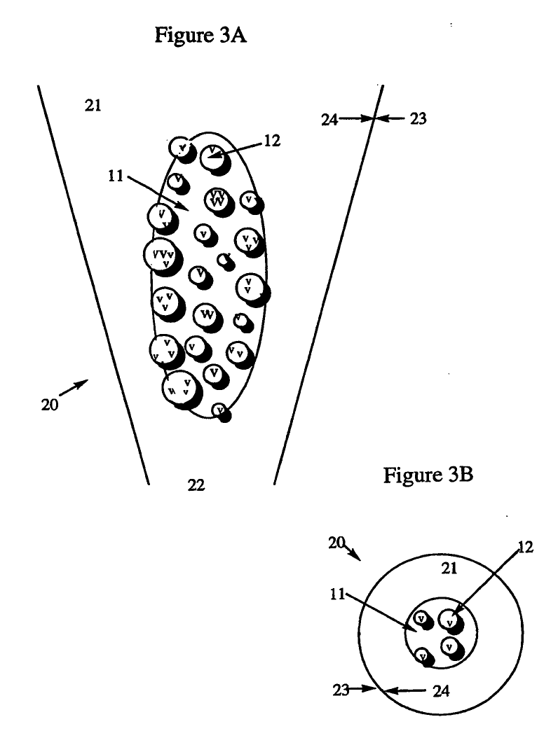

FIG. 3A is a housing (e.g., pipette tip) 20 that has a narrow opening at the bottom end 22, a wider opening at the top end 21, an exterior wall 23 and an interior wall 24. The housing 20 contains an insert 11 coated with secondary supports 12 that are coated with binding materials v. The insert 11 is magnetic and/or magnetizable, and is suspended in the analyte flow path in the housing 20. The external magnetic field is not shown.

FIG. 3B is a top view of the housing 20 of FIG. 3A. The housing 20 has an exterior wall 23 and an interior wall 24. The insert 11 is coated with secondary supports 12 that are coated with binding materials v. As can be seen from FIG. 3B, the insert 11 is suspended within the sample flow path of the housing 20, the insert 11 is not physically attached to the inside wall of the housing 20, does not significantly block the liquid sample flow through the housing 20, and does not create significant back pressure in the housing. The external magnetic field is not shown.

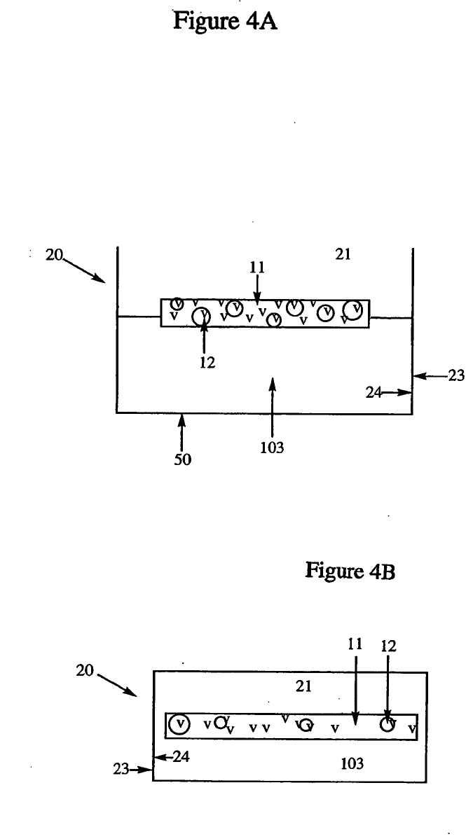

FIG. 4A is a housing (e.g., container) 20 that has a closed bottom end 50, an open top end 21, an exterior wall 23 and an interior wall 24. The housing 20 contains an insert 11 coated with secondary supports 12, where the insert 11 and secondary supports 12 are both coated with binding materials v. The insert 11 is suspended in the analyte flow path in the housing 20 and is capable of floating in the liquid sample 103.

FIG. 4B is a top view of the housing 20 of FIG. 4A. The housing 20 has an exterior wall 23 and an interior wall 24. The insert 11 is coated with secondary supports 12, where the insert 11 and secondary supports 12 are both coated with binding materials v. As can be seen from FIGS. 4A and 4B, the insert 11 floats in the liquid sample within the sample flow path of the housing 20, the insert 11 is not physically attached to the inside wall of the housing 20 and does not significantly block the liquid sample flow in the housing 20.

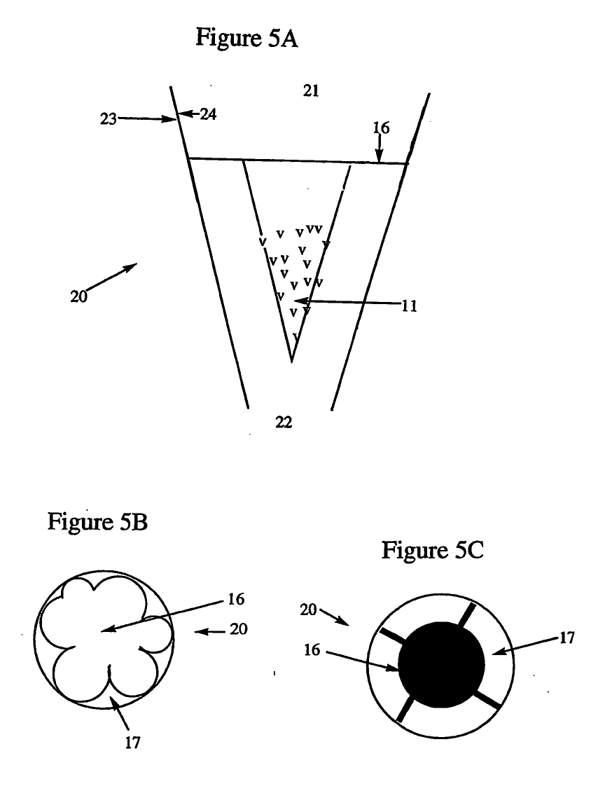

FIG. 5A is a tapered housing (e.g., pipette tip) 20 that has an open bottom end 22, an open top end 21, an interior wall 24 and an exterior wall 23. The housing 20 contains an insert 11 coated with binding materials v. The housing 20 has a configuration where the inner diameter of the bottom end 22 is less than the inner diameter of the top end 21. The insert 11 is held in place through a supportive structure 16 that is permanently or removably attached to the insert 11, which is permanently or removably attached to the interior wall 24 of the housing 20, but that does not significantly obstruct the liquid sample flow through the housing 20 because of the flow channels (not shown) in the structure 16. Additionally, the structure 16 does not create significant back pressure. One skilled in the art will appreciate that the insert 10 shown in FIG. 5A can optionally be any of the inserts 11 shown in FIG. 1.

FIGS. 5B and 5C show different top views of the housing 20 of FIG. 5A. The insert (not shown) is attached to and held in place by a structure 16 that has flow channels 17 which allow for sample flow. Because of the flow channels 17 in the structure 16, the structure 16 does not significantly obstruct the flow of analyte through the housing 20, and the structure 16 does not create significant back pressure. The structure 16 can have any size, shape or thickness, provided that it has one or more flow channels 17 so that it does not significantly obstruct the flow of liquid sample through the housing and does not create significant back pressure. FIG. 5B shows that a cone-shaped insert can have a ribbed surface which creates support and flow channels 17. In one embodiment, the structure 16 can by physically and/or chemically modified (e.g., coated) with binding materials, such as those described herein. FIGS. 5A-C show the structure 16 at the top of the insert 11, and one skilled in the art will appreciate that the structure 16 can be located at any point (e.g., top, bottom, sides) along the insert 11.

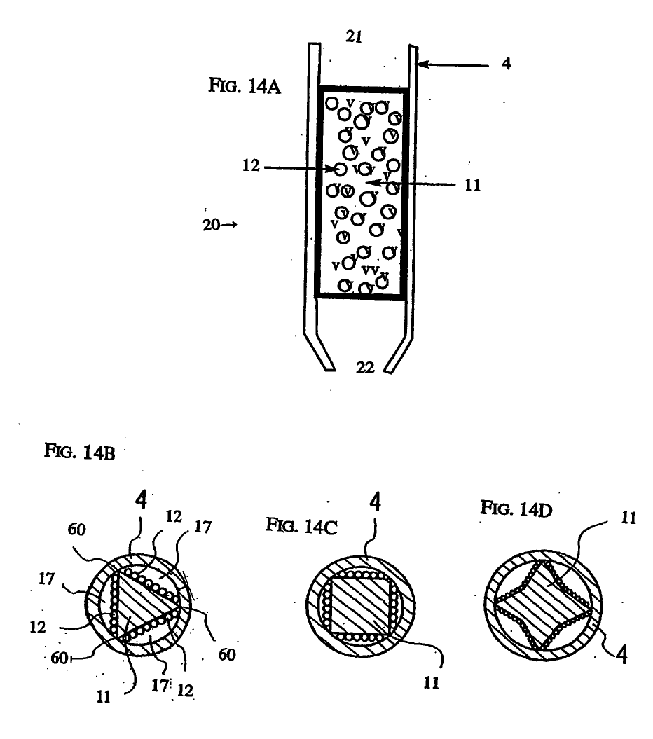

FIG. 14A is a tapered housing (e.g., pipette tip) that has an open bottom end 22, a top end 21 and a wall 4. The housing 20 contains an insert 11 coated with secondary supports 12, where the insert 11 and secondary supports 12 are coated with binding materials v that can reversibly immobilize an analyte of interest. With reference to FIGS. 14B-D (which show a top cross-sectional view of the housing of FIG. 14A) the insert 11 is held in place through the ends 60 of the insert 11 that are in physical contact with the inside wall 4 of the housing 20. The insert 11 can be manually or automatically placed into the housing 20. The insert 11 does not significantly obstruct the liquid sample flow through the housing 20 and does not create significant back pressure due to flow channels 17 in the insert 11. FIGS. 14B-D show various top cross-sectional views of the different shapes that the insert 11 can have. One skilled in the art will appreciate that the insert 11 shown in FIGS. 14A-D can optionally be any of the inserts 11 shown in FIG. 1 with respect to the use of secondary supports and the location of the binding materials.

The housings 20 of the invention can have a cap (not shown) or other mechanism (not shown) to close one or both ends of the housing 20. Such a cap or similar device may be physically attached or removably attached to the housing 20. For example, the cap can be a snap-on cap or a screw-on cap.

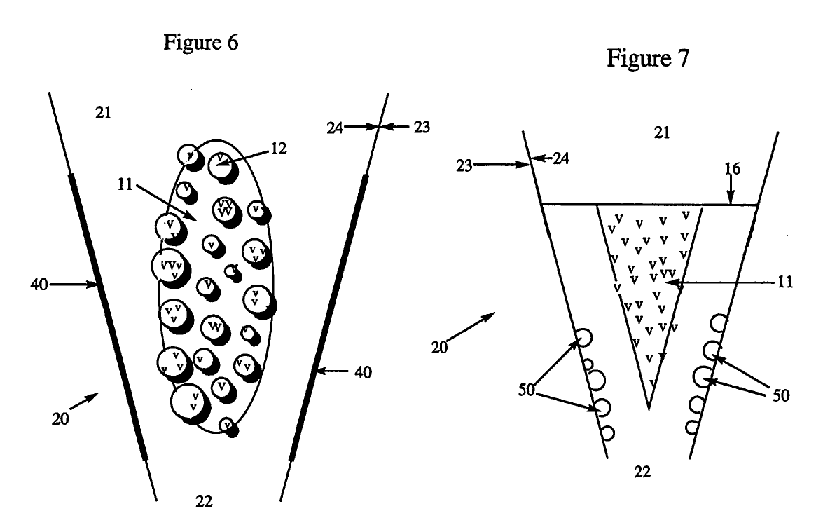

With reference to FIGS. 6 and 7, the housing (e.g., pipette tip) 20 contains an insert 11, as described herein, and a coating 40, 50 on at least a portion of the inside walls 24 of the housing 20. Coatings 40, 50 on at least a portion of the inside walls 24 of the housing 20 are known in the art and described, for example, in U.S. Pat. Nos. 6,416,716 and 6,537,502, the disclosures of which are incorporated by reference herein in their entirety. The coating 40, 50 does not significantly obstruct the flow of liquid sample through the housing 20, and does not create significant back pressure. The coating 40, 50 on at least a portion of the inside walls 23 of the housing 20 can comprise binding materials (v) that are capable of immobilizing an analyte of interest, such as those described herein.

As described in U.S. Pat. No. 6,537,502 and shown in FIG. 6, the coating 40 on at least a portion of the inside walls 24 of the housing 20 can comprise an inert material and binding materials. The coating 40 does not significantly obstruct the flow of the liquid sample through the housing 20. The binding materials used for the coating 40 on the inside walls 24 of the housing 20 can be any known in the art, such as those described herein. The inert material in the coating can be any inert material known in the art (e.g., polymers), such as those described herein. FIG. 6 is an embodiment of the invention where the insert 11 is coated with secondary supports 12 that are coated with binding materials v. One skilled in the art will appreciate that the insert 11 shown in FIG. 6 can optionally be replaced with the insert 11 described, for example, in FIG. 1 or 14.

As described in U.S. Pat. No. 6,416,716 and shown in FIG. 7, binding materials 50 can be adhered to (e.g., embedded on/in) at least a portion of the inside walls 24 of the housing 20. The binding materials 50 can optionally be adhered to the inside walls 24 of the housing 20 in a random and discontinuous manner, and/or can be adhered to the inside walls 24 of the housing 20 by heat application, pressure application, or a combination thereof. The binding materials 50 used on the inside walls 24 of the housing 20 can be any known in the art, such as those described herein. In another embodiment of FIG. 7, secondary supports 50 are coated with binding materials (not shown) where the secondary supports 50 are directly adhered to (e.g., embedded on/in) at least a portion of the inside walls 24 of the housing 20. FIG. 7 provides an embodiment of the invention where the insert 11 is one described in FIGS. 1 and 5.

The devices of the invention can be used in any biological, chemical, and/or biochemical application, such as those described herein. The devices of the invention may be used in bi-directional fluidic applications (e.g., from the bottom end of the housing to the top end of the housing and/or from the top end of the housing to the bottom end of the housing). The devices of the invention may be used with any robotic system or automated apparatus, such as computer-controlled bench-top systems designed for performing pipetting operations.

The devices of the invention may be used for filtering, separating, enriching and/or purifying analytes of interest (e.g., biomolecules such as oligonucleotides, peptides, DNA, RNA, and proteins) from liquid samples using binding materials, such as chromatography materials. Chromatographic methods for filtering, separating and/or purifying bio-materials are known in the art. In the invention, analytes may be filtered, separated and/or purified by adding the liquid sample containing the analytes to the top end of the pipette tip. Alternatively, analytes may be filtered, separated and/or purified by pipetting the liquid sample containing the analytes up from the bottom end into the pipette tip from, for example, a well plate, beaker, or other source. Solvents (e.g., weak eluting solvents) may then be added to the housing to remove the impurities from the analyte and to maintain the analyte of interest in the housing. After the impurities have been removed, the purified analyte may be eluted from the binding materials on the insert with an appropriate solvent or buffer (e.g., relatively stronger eluting solvent or buffer).

The housings of the invention may be use in any repetitive chemical process requiring synthesis or degradation. For example, the housings may be used in the synthesis of a variety of oligomers, such as polypeptides, polysaccharides, and oligonucleotides. The housings of the invention may also be used for preparing biomolecules (e.g., oligonucleotides, peptides, DNA, RNA, proteins). For example, oligonucleotides may be prepared using the housings of the invention. An initial protected nucleoside may be bound via the terminal 3′-hydroxyl group to a solid support (e.g., chromatographic material) in the housing. The initial protected nucleoside may be bound to the insert when the housing is made. Alternatively, the initial protected nucleoside may be added to a housing which has been made to contain appropriate chromatographic materials that will bind and retain the nucleoside.

Reagents and solvents may be added to the devices to consecutively remove and add sugar protecting groups to generate specific chemical moieties to provide a stepwise addition to the growing oligonucleotide chain. The steps for preparing oligonucleotides, e.g., deblocking, activating/coupling, oxidating, capping, are known in the art and may be followed to produce oligonucleotides in the devices of the invention. Once the oligonucleotides are formed, they may be removed from the devices using known reagents.

Cell lines (including hybridomas) can be cultured in the devices of the invention, including, for example, cell lines available from the ATCC and the ECACC. The cell cultures can be grown from normal, embryonic and malignant tissues. For adherent cells, the inserts in the housings may have a suitable surface on which the cells may adhere. For growing adherent cells, the housing and inserts may preferably comprise polystyrenes, polypropylene, polytetrafluoroethylenes, polyvinylchlorides, polycarbonates, and/or titanium.

The devices of the invention may be used for running assays. Assays known in the art involve complementary binding pairs including, for example, enzyme-linked immunosorbent assays (ELISA), sandwich assays, competitive assays, latex agglutination assays, radio-immunoassays (RIA), fluorescent immunoassays (FIA), and the like. To use the devices of the invention to conduct a binding assay (e.g., receptor-ligand assay), a liquid sample comprising a protein analyte (e.g., receptor) may be added to the housing that comprises a chromatographic material capable of binding the protein analyte. Alternatively, the housing may be constructed to contain the proteins of interest. A second analyte comprising small molecules (e.g., ligand) may then be added to the housing, but which can only bind to the proteins in the housing. After the second analyte passes through the housing, the bound protein-small molecule materials may then be eluted with the appropriate solvent or buffer. Quantitative and/or qualitative assays may then be performed to further study the eluted analytes. By choosing appropriate chromatographic materials, the devices of the invention may also be used to study DNA-protein interactions, protein-protein interactions, and many other interactions between biomolecules and other molecules.

In another embodiment, the invention provides an apparatus for identifying analytes comprising a housing and an insert, where the insert is an indicator insert. The indicator can be any known in the art, such as dyes. The indicator insert can be porous or non-porous. The insert can be coated with a chemical dye or can be a porous insert that contains a dye. The dye can be a solid (e.g., powder, pellets, microspheres and the like) or a liquid. The insert can be of any size or shape, and can float within the housing and/or be secured within the housing as described herein. In this embodiment of the invention, the sample comprising the analyte is brought into the housing and, upon contact of the analyte with the insert, will activate the dye to produce a color change on/in the insert. The color change will indicate the presence of an analyte of interest. If there is no color change, the analyte of interest is not present.

The devices, inserts and/or housings of the invention may be in the form of a kit. The kit may comprise the devices, inserts and/or housings of the invention and any materials known in the art, such as any materials used in performing the methods described herein. For example, the kit may comprise one or more inserts, housing (e.g., pipette tips of the invention or other pipette tips), caps for the housings, collection tubes, well plates, clamps, membranes, growth blocks, filters, plate rotators, syringes, chromatographic materials, reagents, buffers, cells, and/or a user manual. The term “kit” includes, for example, each of the components combined in a single package, the components individually packaged and sold together, or the components presented together in a catalog (e.g., on the same page or double-page spread in the catalog).

### EXAMPLES

The following examples are for purposes of illustration only and are not intended to limit the scope of the appended claims.

### Example 1

An array of multiple inserts will be prepared by dipping a three-dimensional polymeric body into a polymer coating solution. The polymer coating solution will be at a temperature slightly above the melting point of the polymer and the array of inserts will be dipped into the polymer coating solution for a period of time sufficient to coat the inserts. Thereafter, the array of inserts will be removed from the polymer coating solution and will be air dried.

Separately, a powder bath that will contain binding materials that can reversibly immobilize a analyte of interest will be prepared. For example, C₁₋₈ alkyl ligands will be heat dried in a shallow dish at a temperature from about 80° C. to about 90° C. The array of inserts that have previously been coated with a polymer (e.g., polytetrafluoroethylene) will then be dipped/rolled in the powdered C18 alkyl ligands at a temperature where the polymer (e.g., polytetrafluoroethylene) softens so that the C18 alkyl ligands will adhere to the polymer (e.g., polytetrafluoroethylene) on the inserts. The C18 alkyl ligands can be partially embedded in the polymer (i.e., this can be considered a matrix). Loose C18 alkyl ligands will be tapped off of the inserts.

### Example 2

The method described in Example 1 will, in one embodiment, produce the insert array shown in FIG. 8. The insert array can have a primary connector 101 that holds the array of inserts 11, a handle 201 that connects each individual insert 11 to the primary connector 101, and binding materials v that cover at least a portion of the insert 11. The array of inserts will then be placed into housings (e.g., pipette tips) 20 as shown in FIG. 9. Thereafter, the connectors 201 will be cut so that the inserts 11 drop into the pipette tips 20. The pipette tips can then be released into a storage rack for packaging.

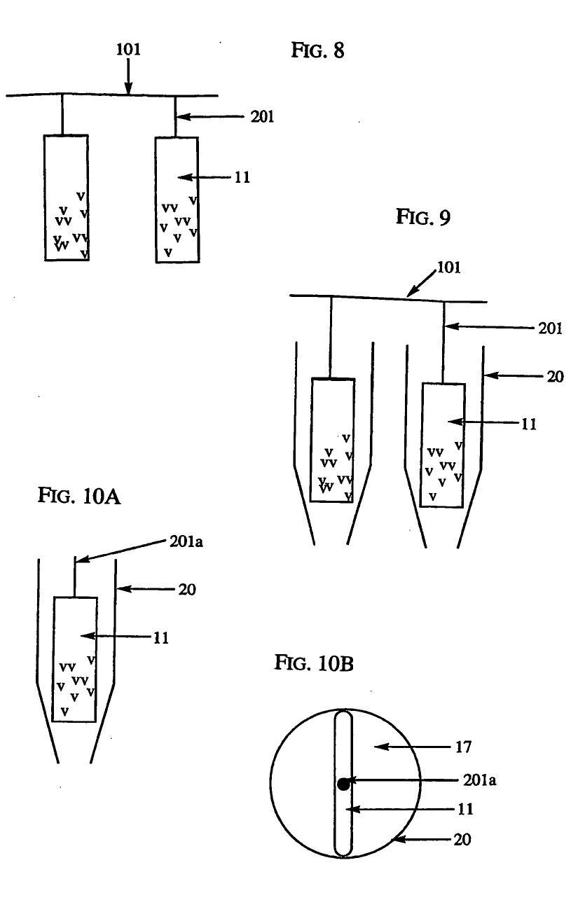

As shown in FIGS. 10A and 10B, the resulting pipette tip 20 will contain an insert 11, of which at least a portion is coated with binding materials v that will be capable of reversibly immobilizing a analyte of interest, and a cut secondary connector 201a. FIG. 10B, which is a top view of the pipette tip 20 shown in FIG. 10A shows that the insert 11 will not substantially block the flow of liquid sample (which comprises the analyte) through the pipette tip and will not create significant back pressure because there is a flow channel 17 between the insert 11 and the inside walls of the pipette tip 20. The figures also show that the insert 11 can physically touch the inside walls of the housing 20, but that the insert 11 will not be physically connected to the inside walls of the housing 20.

This embodiment of the invention referenced in FIG. 10 differs from those previously described by showing that the insert of the invention can be placed within a housing without the use of magnetic controls (e.g., as shown in FIGS. 2-4 and 6) and without the use of support structures 16, such as those shown in FIGS. 5 and 7.

### Example 3

This example demonstrates the use of insert arrays of the invention for producing analytes for analytical techniques, e.g., mass spectrometry, high performance liquid chromatography, electrophoresis and the like.

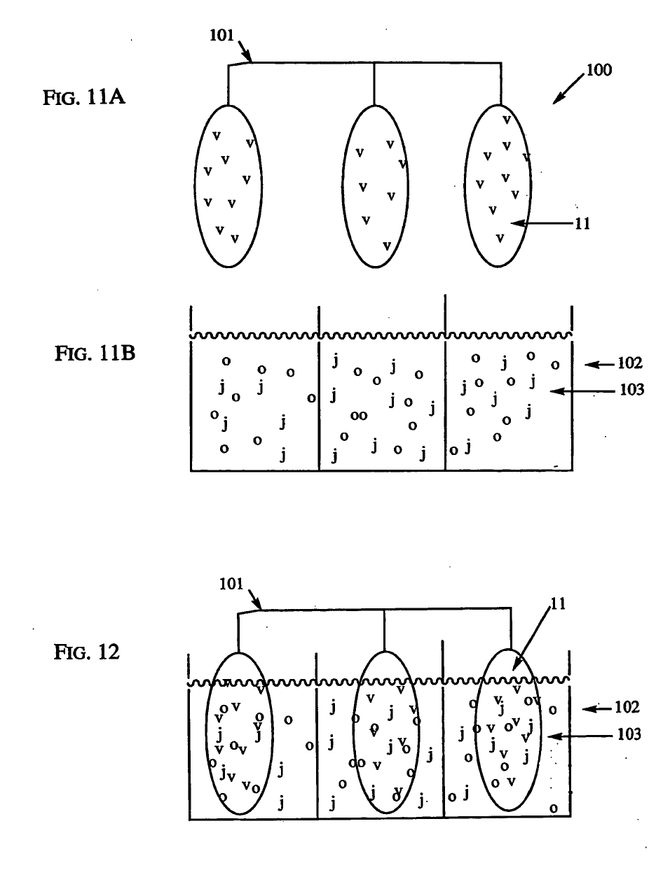

FIG. 11 shows an array 100 of inserts 11 of which at least a portion will be coated with binding materials v that will be capable of reversibly immobilizing an analyte of interest o. For example, the binding materials v can be chromatographic media, such as C18, and the analyte of interest o can be a peptide. Multiple inserts can be in the form of an array 100, where the array 100 is connected via structures 101 that will be manipulated for the experiment either automatically (e.g., through robotics) or manually. In alternative embodiments, the inserts can be within housings, such as those described herein and shown in FIGS. 9 and 10.

With reference to FIG. 11B, a housing 102 will hold a liquid sample 103 which will contain, inter alia, the analyte of interest o and contaminates j. The contaminates j can be, for example, salts and/or detergents. In one embodiment, the housing 102 can be a titer well or a microtiter well in a singular format, a strip format or an array format. For analytical techniques, such as mass spectrometry, the analyte of interest o will have to be concentrated (e.g., enriched) prior to analysis.

With reference to FIG. 12, the array comprising the multiple inserts 11 will be immersed into the liquid sample 103 in the housing 102. The array can optionally be immersed in and out of the liquid sample 103 in the housing 102 numerous times to ensure sufficient opportunities for contact between the binding materials v and the analyte of interest o. The binding materials v on the inserts 11 will be pre-selected on the basis of their ability to preferentially reversibly immobilize the analyte of interest o and not the contaminates j in the liquid sample 103. If the array was in the form of pipette tips containing the inserts, the liquid sample 103 which will contain the analyte of interest o and contaminates j will be aspirated in and out of the pipette tip for the same purpose.

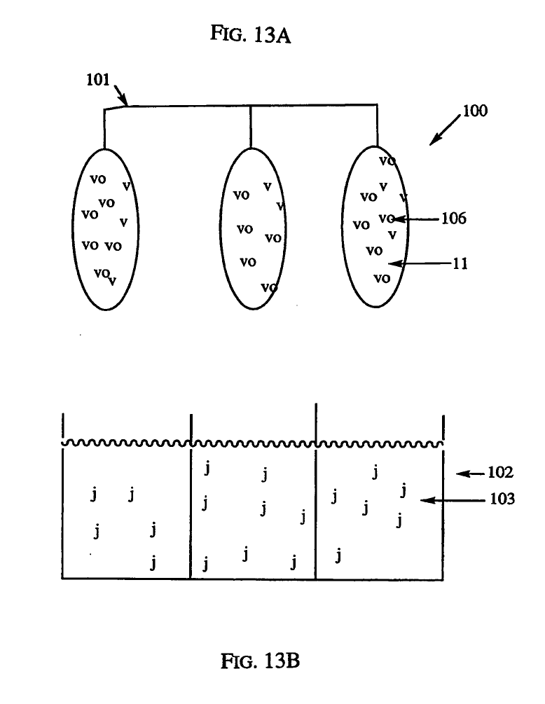

With reference to FIG. 13A, the array 100 comprising the inserts 11 will be removed from the housing 102 and the binding materials v will have reversibly immobilized the analyte of interest o to form a complex 106 (also shown as vo in the figure). As shown in FIG. 13B, the housing 102 will be holding the liquid sample 103 containing the contaminates j.

Thereafter, the inserts 11 will be washed to elute the analyte of interest o into another housing or directly to a mass spectrometer target. One skilled in the art will be able to select the appropriate solvent(s) to elute the analyte of interest o from the particular complex 106 that was formed. This will result in a purified and concentrated analyte of interest o.

Various modifications of the invention, in addition to those described herein, will be apparent to one skilled in the art from the foregoing description. Such modifications are intended to fall within the scope of the appended claims.

1. An insert comprising a three-dimensional body that is at least partially coated with one or more binding materials that can immobilize an analyte of interest.

2. The array of claim 1, wherein the three-dimensional body is made of one or more polymers.

3. The array of claim 1, wherein the three-dimensional body has one or more vertical ribs.

4. The array of claim 1, wherein the one or more binding materials are chromatographic materials.

5. A device comprising a linear strip of the inserts of claim 1.

6. A device comprising an array of the inserts of claim 1.

7. The array of claim 6, wherein the array comprises 2, 4, 8, 12, 16, 24, 48, 96, 384 or 1,536 inserts.

8. A housing defining a volume and comprising an open top end and an insert, wherein the insert is at least partially coated with binding materials that can immobilize an analyte of interest; wherein the insert is within the volume of the housing; and wherein the insert does not significantly obstruct liquid sample flow through the housing.

9. The housing of claim 8, wherein the insert does not create substantial back pressure.

10. A housing defining a volume and comprising an open top end and an insert, wherein the insert is at least partially coated with binding materials that can immobilize an analyte of interest; wherein the insert is within the volume of the housing; and wherein the insert does not create substantial back pressure.

11. The housing of claim 10, wherein the insert does not significantly obstruct liquid sample flow through the housing.

12. The housing of claim 8 or 10, wherein the insert is physically attached to the housing by a support structure, wherein the support structure does not significantly obstruct liquid sample flow through the housing.

13. The housing of claim 8 or 10, wherein the insert physically contacts at least a portion of the inside wall of the housing but is not physically connected thereto.

14. The housing of claim 8 or 10, wherein the housing comprises an open bottom end.

15. The housing of claim 8 or 10, wherein the insert has one or more vertical ribs.

16. The housing of claim 8 or 10, wherein the binding materials are chromatographic materials.

17. The housing of claim 8 or 10, wherein the inside wall of the housing is coated with binding materials that can immobilize an analyte of interest.

18. The housing of claim 8 or 10, wherein the housing is a pipette tip, a syringe, a column, an open-bottom tube, a container, a flask, a beaker, a petri dish, or a closed-bottom tube.

19. The housing of claim 8 or 10, wherein the housing defines a volume from about 0.0001 ml to about 1000 ml.

20. A device comprising a linear strip of the housings of claim 8 or 10.

21. A device comprising an array of the housings of claim 8 or 10.

22. The device of claim 21, wherein the array comprises 2, 4, 8, 12, 16, 24, 48, 96, 384 or 1,536 housings.

23. A method for enriching an analyte of interest comprising:
(i) providing an insert which comprises a three-dimensional body that is at least partially coated with binding materials that can reversibly immobilize an analyte of interest;
(ii) providing a housing with a closed bottom end, wherein the housing comprises a liquid sample, and wherein the liquid sample comprises the analyte of interest and at least one contaminate;
(iii) immersing the insert into the housing for a period of time sufficient for the binding materials to immobilize at least a portion of the analyte of interest;
(iv) removing the insert from the housing;
(v) washing the insert to remove the analyte of interest from the binding materials; and
(vi) collecting the enriched analyte of interest.

24. The method of claim 23, wherein the housing is a titer well.

25. The method of claim 23, wherein the insert is in the form of a linear strip of inserts and wherein the housing is in the form of a linear strip of housings.

26. The method of claim 23, wherein the insert is in the form of an array of inserts and wherein the housing is in the form of an array of housings.

27. The method of claim 23, wherein the method is automated.

28. A method for enriching an analyte of interest comprising:
(i) providing a first housing that defines a volume and comprises at least one open end and an insert which comprises a three-dimensional body that is at least partially coated with binding materials that can reversibly immobilize an analyte of interest, wherein the insert does not significantly obstruct liquid sample flow through the housing;
(ii) providing a second housing with a closed bottom end, wherein the second housing comprises a liquid sample, and wherein the liquid sample comprises the analyte of interest and at least one contaminate;
(iii) immersing the first housing into the second housing for a period of time sufficient for the binding materials to immobilize at least a portion of the analyte of interest;
(iv) removing the first housing from the second housing;
(v) washing the insert in the first housing to remove the analyte of interest from the binding materials; and
(vii) collecting the enriched analyte of interest.

29. The method of claim 28, wherein the insert does not create substantial back pressure.

30. A method for enriching an analyte of interest comprising:
(i) providing a first housing that defines a volume and comprises at least one open end and an insert which comprises a three-dimensional body that is at least partially coated with binding materials that can reversibly immobilize an analyte of interest, wherein the insert does not create substantial back pressure;
(ii) providing a second housing with a closed bottom end, wherein the second housing comprises a liquid sample, and wherein the liquid sample comprises the analyte of interest and at least one contaminate;
(iii) immersing the first housing into the second housing for a period of time sufficient for the binding materials to immobilize at least a portion of the analyte of interest;
(iv) removing the first housing from the second housing;
(v) washing the insert in the first housing to remove the analyte of interest from the binding materials; and
(vii) collecting the enriched analyte of interest.

31. The method of claim 30, wherein the insert does not significantly obstruct liquid sample flow through the housing.

32. The method of claim 28 or 30, wherein the method is automated.

33. The method of claim 28 or 30, wherein the second housing is a titer well.

34. The method of claim 28 or 30, wherein the first housing is in the form of a linear strip and wherein the second housing is in the form of a linear strip.

35. The method of claim 28 or 30, wherein the first housing is in the form of an array and wherein the second housing is in the form of an array.

36. A kit comprising (i) one or more microtiter wells and (ii) one or more housings that define a volume and comprise at least one open end and an insert which comprises a three-dimensional body that is at least partially coated with binding materials that can reversibly immobilize an analyte of interest, wherein the insert does not significantly obstruct liquid sample flow through the housing.

37. The kit of claim 36, wherein the insert does not create substantial back pressure.

38. A kit comprising (i) one or more microtiter wells and (ii) one or more housings that define a volume and comprise at least one open end and an insert which comprises a three-dimensional body that is at least partially coated with binding materials that can immobilize an analyte of interest, wherein the insert does not create substantial back pressure.

39. The kit of claim 38, wherein the insert does not significantly obstruct liquid sample flow through the housing.

40. An insert comprising a three-dimensional body that comprises one or more alkyl ligands covalently bonded to polytetrafluoroethylene, wherein the polytetrafluoroethylene is a coating on the insert.
